(19) United States
(12) Patent Application Publication
(10) Pub. No.: US 2025/0251887 A1
(43) Pub. Date: Aug. 7, 2025

(54) CONTROL DEVICE, NON-TRANSITORY COMPUTER-READABLE RECORDING MEDIUM STORING COMPUTER-READABLE INSTRUCTIONS FOR CONTROL DEVICE, AND METHOD EXECUTED BY CONTROL DEVICE

(71) Applicant: BROTHER KOGYO KABUSHIKI KAISHA, Nagoya (JP)

(72) Inventor: Yoshifumi YAHASHI, Nagoya (JP)

(21) Appl. No.: 19/044,765

(22) Filed: Feb. 4, 2025

(30) Foreign Application Priority Data
Feb. 7, 2024 (JP) 2024-016993

(51) Int. Cl. G06F 3/12; G06Q 30/0283

(52) U.S. Cl. CPC G06F 3/1269; G06F 3/1205; G06F 3/1288; G06Q 30/0283

(57) ABSTRACT

The control device may acquire printer information related to a printer and may specify first combination information adapted to the printer information from among a plurality of combination information in a memory. Each of the plurality of combination information may indicate a combination of a model name of a printer and plan information indicating a content of a plan included in a service related to the printer, and the first combination information includes a first model name and first plan information. The control device may output the first combination information.

### REFERENCE TO RELATED APPLICATION

This application claims priority to Japanese Patent Application No. 2024-016993 filed on Feb. 7, 2024. The entire content of the priority application is incorporated herein by reference.

### BACKGROUND ART

A technology is known that calculates multiple costs corresponding to multiple price plans based on log information of image processing executed by an image processing device and presents the most inexpensive price plan to a user.

### SUMMARY

The disclosure herein provides a technology for presenting useful information to a user.

The disclosure herein provides a non-transitory computer-readable recording medium storing computer-readable instructions for a control device comprising a processor. The computer-readable instructions, when executed by the processor, may cause the control device to: acquire printer information related to a printer; specify first combination information adapted to the printer information from among a plurality of combination information in a memory, wherein each of the plurality of combination information indicates a combination of a model name of a printer and plan information indicating a content of a plan included in a service related to the printer, and the first combination information includes a first model name and first plan information; and output the first combination information.

According to the configuration above, when acquiring printer information related to a printer, the control device specifies first combination information adapted to the printer information from among a plurality of combination information stored in the memory and outputs the first combination information. Thus, the control device can output the useful information to a user.

The above control device itself and a method executed by the above control device are also novel and useful. Further, a communication system including the above control device and a printer is also novel and useful.

### BRIEF DESCRIPTION OF DRAWINGS

FIG. 1 shows a configuration of a communication system.

FIG. 2 shows examples of tables.

FIG. 3 shows a sequence of actions performed by devices.

FIG. 4 shows a result screen in Case A.

FIG. 5 shows a result screen in Case B.

FIG. 6 shows a result screen in Case C.

FIG. 7 shows a result screen in Case D according to a second embodiment.

FIG. 8 shows a sequence of actions by devices in a third embodiment.

FIG. 9 shows a result screen in Case E according to the third embodiment.

FIG. 10 shows a result screen in Case F according to a fourth embodiment.

### DESCRIPTION

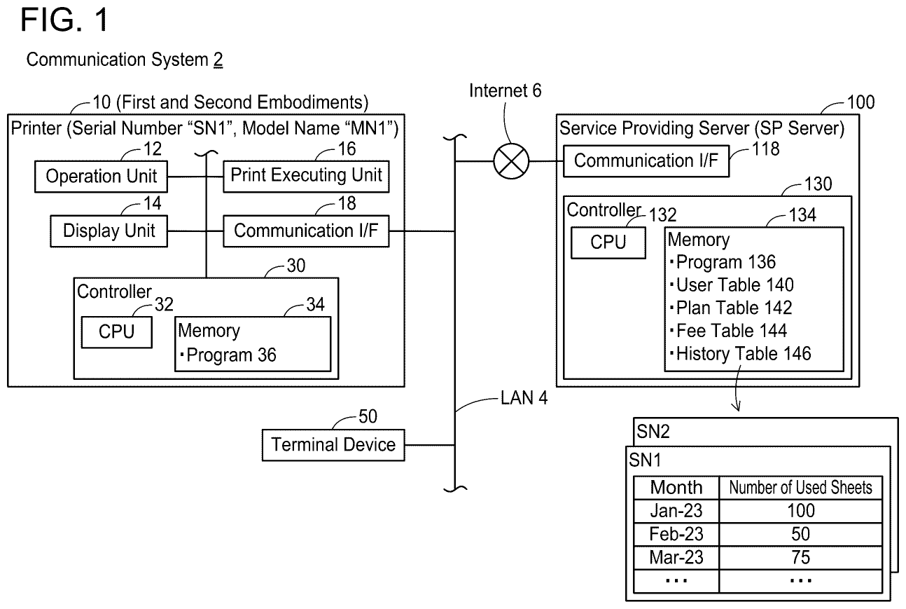

### (Configuration of Communication System 2: FIG. 1)

As shown in FIG. 1, a communication system 2 comprises a printer 10, a terminal device 50, and a service providing server 100. The printer 10 and the terminal device 50 are connected to a local area network (LAN) 4 and communicable with each other via the LAN 4. The terminal device 50 may be a portable terminal device such as a mobile phone (e.g., a smartphone), a PDA, a laptop PC, or a tablet PC, or a stationary terminal device such as a desktop PC. The LAN 4 is connected to the internet 6. The service providing server 100 is connected to the internet 6. Hereinafter, the service providing server 100 is termed “SP server 100”.

### (Configuration of Printer 10)

The printer 10 is a peripheral device (i.e., a peripheral device of the terminal device 50 or the like) configured to execute a print function. The printer 10 may be a multifunctional device configured to execute a scan function, a FAX function, etc. in addition to the print function. The printer 10 has a serial number “SN1” and a model name “MN1”. Serial numbers are identification numbers assigned to printers during their manufacture and thus are unique information for identifying individual printers. Model names indicate models or product names of printers. Model names are information that may be assigned to printers.

The printer 10 comprises an operation unit 12, a display unit 14, a print executing unit 16, a communication interface 18, and a controller 30. The operation unit 12 is a user interface for a user to input various information to the printer 10. The operation unit 12 comprises, for example, a touch screen for displaying software keys (operation objects), hardware keys, or both of them. The display unit 14 is a display or a panel for displaying various information. The panel is, for example, a liquid crystal panel or an organic EL panel. The panel may or may not be a touch screen. The print executing unit 16 comprises a print engine of inkjet scheme, electrophotographic scheme, or thermal scheme. The communication interface 18 is connected to the LAN 4. The communication interface 18 may be an interface for wireless communication or an interface for wire communication.

The controller 30 comprises a CPU 32 and a memory 34. The memory 34 comprises a volatile memory and a non-volatile memory. The volatile memory comprises a RAM and a cache memory. The non-volatile memory comprises a ROM, flash memory, a solid state drive (SSD), a hard disk drive (HDD), or a combination thereof. A program 36 is stored in the non-volatile memory. The program 36 in the non-volatile memory is loaded to the volatile memory and the CPU 32 executes the program 36, thereby implementing various processes.

### (Configuration of SP Server 100)

The SP server 100 is established on the internet 6 by the vendor of the printer 10. In a modification, the SP server 100 may be established on the internet 6 by a business operator different from the vendor. In another modification, the vendor may not prepare hardware for the SP server 100 and may use an environment provided by an external cloud computing service. In this case, the vendor prepares a program (i.e., software) for implementing the SP server 100 and introduces it into the above environment. The SP server 100 may be a single server or a collectivity of multiple servers.

The SP server 100 provides a subscription service related to printers. The subscription service charges only a basic fee when the number of sheets used within a unit period (e.g., one month) is at or below the upper limit for the number of available sheets (e.g., 1000 sheets), while the subscription service charges, when the number of sheets used within the unit period exceeds the upper limit, a sum of the basic fee and an additional fee for the excess sheets used beyond the upper limit. The subscription service includes an automatic shipping service of automatically shipping a new cartridge when the remaining amount of a color material (e.g., ink, toner, etc.) in the cartridge used in a printer becomes equal to or less than a predetermined remaining amount. The price of the cartridge is included in the basic fee of the subscription service.

The SP server 100 comprises a communication interface 118 and a controller 130. The communication interface 118 is connected to the internet 6. The controller 130 comprises a CPU 132 and a memory 134. The CPU 132 is configured to execute various processes according to a program 136 stored in the memory 134. The memory 134 comprises a volatile memory and a non-volatile memory. The memory 134 is the same as the memory 34 of the printer 10. The program 136 in the non-volatile memory is loaded to the volatile memory and the CPU 132 executes the program 136, thereby implementing various processes. A user table 140, a plan table 142, a fee table 144, and a history table 146 are also stored in the memory 134.

In the history table 146, months and the numbers of used sheets are associated with each other for each printer serial number. Each printer sends its serial number and the cumulative number of sheets used therein to the SP server 100 on a regular basis (e.g., every day, every hour, or the like). Thus, the SP server 100 can calculate, for each printer, the total number of sheets used within one month and store it. Hereinafter, information stored in the history table 146 may be referred to as “history information”.

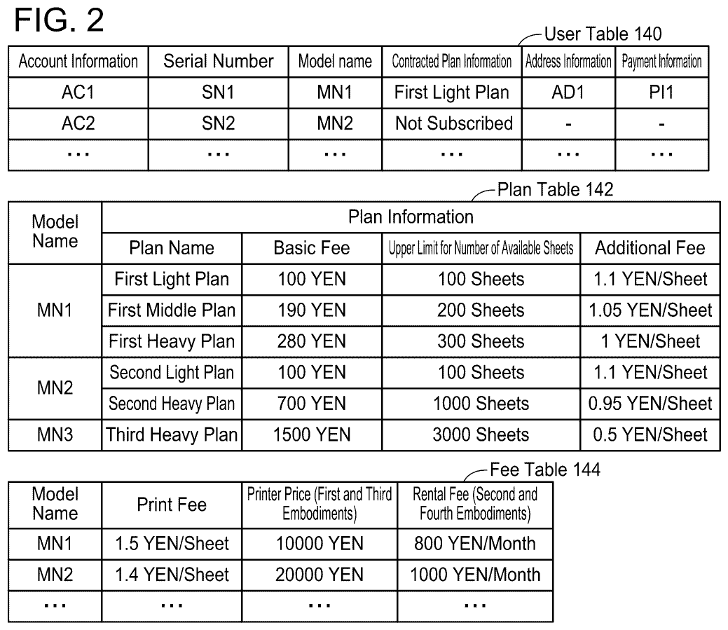

### (Contents in Tables 140, 142, and 144: FIG. 2)

Referring to FIG. 2, contents in the user table 140, the plan table 142, and the fee table 144 in the SP server 100 are described.

In the user table 140, account information, serial numbers, model names, contracted plan information, address information, and payment information are stored in association with each other. Each account information is information used for a user to log into the SP server 100 and includes a user ID and a password. Each contracted plan information indicates a plan name of a plan of the subscription service contracted by a user. If a user has not subscribed to the subscription service yet, contracted plan information indicates “Not Subscribed”. Each address information indicates an address to which a cartridge is to be shipped. Each payment information is used for a user to pay the fee for the subscription service and includes, for example, a credit card number, a credit card expiration date, etc.

When a user accesses the SP server 100 via a terminal device (e.g., 50) and inputs account information (e.g., “AC1”), address information (e.g., “AD1”), and payment information (e.g., “PI1”), these information are stored in the user table 140. At this time, in response to the user performing a predetermined operation on the printer 10, the printer 10 communicates with the SP server 100 to send the serial number “SN1” and the model name “MN1” of the printer 10 to the SP server 100. The SP server 100 then stores the serial number “SN1” and the model name “MN1” in association with the account information “AC1”. Further, the user can select a plan of the subscription service while logged in the SP server 100. The SP server 100 thus stores contracted plan information in association with the account information “AC1”.

In the plan table 142, model names and plan information are stored in association with each other. Each plan information includes a plan name, a basic fee, an upper limit for the number of available sheets, and an additional fee. Each plan name indicates a name of plan supported by the model associated with the plan name. The model name “MN1” is associated with a first light plan, a first middle plan, and a first heavy plan. A model name “MN2” is associated with a second light plan and a second heavy plan. A model name “MN3” is associated with a third heavy plan. The light plans are for users that do not use printers much (i.e., casual users). The heavy plans are for users that use printers a lot (i.e., heavy users). The middle plans are for users who use printers moderately, i.e., users between the casual users and the heavy users (i.e., middle users).

In this embodiment, the subscription service charges a usage fee to each user every unit period, which is one month. Each basic fee is a required monthly fee. Each upper limit for the number of available sheets is an upper limit for the number of print media available within one month for the basic fee. Each additional fee is a fee per excess sheet that is charged when the number of used sheets exceeds the upper limit for the number of available sheets. The basic fees, the upper limits for the number of available sheets, and the additional fees are set in advance. Hereinafter, information including a model name and plan information is termed “combination information”.

In the fee table 144, model names, print fees, printer prices are stored in association with each other. Each print fee indicates a fee per sheet that is charged to users who have not subscribed to the subscription service. Each printer price indicates a price to be paid to purchase a printer.

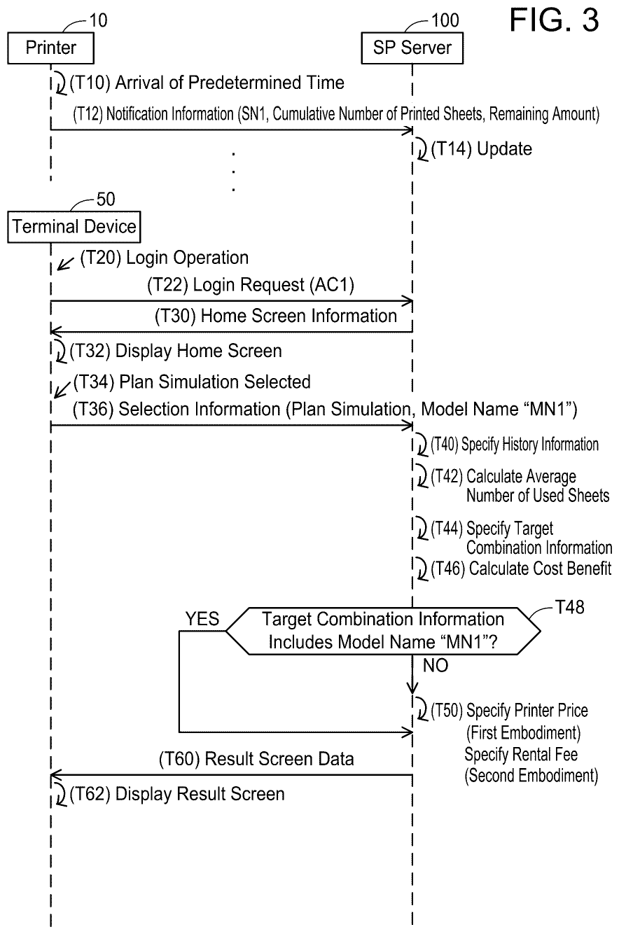

### (Process Executed by Devices: FIG. 3)

Referring to FIG. 3, a process executed by the devices 10, 50, and 100 is described. Hereinafter, in order to facilitate understanding, actions of the CPUs (e.g., the CPUs 32, 132) of the devices will be described as if the devices (e.g., the printer 10, the terminal device 50, the SP server 100) execute the actions, not as if the CPUs execute the actions.

The user of the printer 10 has already accessed the SP server 100 to store the account information “AC1”, the serial number “SN1”, and the model name “MN1” in the user table 140 (see FIG. 2). The user has already subscribed to the subscription service or has not subscribed to the subscription service yet.

The printer 10 determines in T10 that a predetermined time has come, and then sends notification information to the SP server 100 in T12. The predetermined time is, for example, a predetermined time of the day. The notification information includes the serial number “SN1” of the printer 10, the cumulative number of sheets used in the printer 10, and a remaining amount in a cartridge used in the printer 10. This configuration does not require the user to perform any operations to send the cumulative number of sheets used in the printer 10 to the SP server 100.

In response to receiving the notification information from the printer 10 in T12, the SP server 100 updates the history table 146 in T14 using the information included in the notification information. Specifically, notification information that was received from the printer 10 the last time is stored in the SP server 100. The SP server 100 calculates a difference between the cumulative number of used sheets included in the notification information most recently received in T12 and the cumulative number of used sheets included in the notification information received the last time, and adds the difference to the number of used sheets of the month for the serial number “SN1”.

If the user of the printer 10 has already subscribed to the subscription service, the SP server 100 determines whether the remaining amount included in the notification information is equal to or less than the predetermined amount. If the user of the printer 10 has already subscribed to the subscription service, contracted plan information that does not indicate “Not Subscribed” is associated with the serial number “SN1” in the user table 140. When determining that the remaining amount is equal to or less than the predetermined amount, the SP server 100 executes a process for shipping a new cartridge in T14. Specifically, the SP server 100 specifies, in the user table 140, the address information “AD1” associated with the serial number “SN1” included in the notification information, and then outputs an instruction to ship a new cartridge to the destination indicated by the address information “AD1”. This output of the instruction includes, for example, sending the instruction to a terminal of a worker in charge of cartridge shipping. In a modification, the output of the instruction includes, for example, sending the instruction to a shipping server, which is a separate server from the SP server 100.

The printer 10 repeats the action of T12. For example, the printer 10 executes the action of T12 on a regular basis such as every hour. Thus, the SP server 100 also repeats the action of T14.

Next, a process for providing information related to the subscription service to the user of the printer 10 is described.

In T20, the terminal device 50 receives from the user a login operation to log into the SP server 100. The login operation includes input of the account information “AC1”. In T22, the terminal device 50 sends a login request including the account information “AC1” to the SP server 100.

In response to receiving the login request from the terminal device 50 in T22, the SP server 100 authenticates the account information “AC1” included in the login request. In the present case, the authentication of the account information “AC1” succeeds since the account information “AC1” is already in the user table 140 in the SP server 100. In this case, the SP server 100 sends home screen information representing a home screen to the terminal device 50 in T30.

In response to receiving the home screen information from the SP server 100 in T30, the terminal device 50 displays the home screen in T32. The home screen includes a plurality of icons related to the subscription service. The plurality of icons includes an icon for executing a simulation for selection of a plan useful to the user. In response to receiving an operation of selecting the icon and an operation of inputting the model name “MN1” from the user in T34, the terminal device 50 sends selection information including a plan simulation instruction and the model name “MN1” to the SP server 100 in T36.

In response to receiving the selection information from the terminal device 50 in T36, the SP server 100 first specifies the serial number “SN1” associated with the logged-in account information “AC1” in the user table 140 and then specifies the history information for the serial number “SN1” in the history table 146 in T40. The SP server 100 then calculates the average number of used sheets based on the history information in T42. Specifically, the SP server 100 calculates an average value of the number of used sheets one month ago, the number of used sheets two months ago, and the number of used sheets three months ago as the average number of used sheets. Then, the SP server 100 calculates a plurality of print costs corresponding to a plurality of plan information based on the average number of used sheets and the plan table 142, and then specifies one or more combination information adapted to the average number of used sheets in T44. Here, a print cost is a cost per month for the average number of used sheets. Hereinafter, combination information adapted to the average number of used sheets is termed “target combination information”. In this embodiment, the SP server 100 specifies the combination information that includes the plan information resulting in the lowest print cost (which will be termed “combination information with the lowest print cost” hereinafter) as first target combination information and also specifies the combination information that includes the plan information resulting in the second lowest print cost (which will be termed “combination information with the second lowest print cost” hereinafter) as second target combination information. That is, in this embodiment, “adapted to the average number of used sheets” means relatively low print costs. Hereinafter, the lowest print cost and the second lowest print cost are termed “first target print cost” and “second target print cost”, respectively.

In T46, the SP server 100 calculates a first cost benefit and a second cost benefit corresponding to the first target combination information and the second target combination information, respectively. If the user has not subscribed to the subscription service yet, the SP server 100 specifies a print fee “1.5 yen/sheet” associated with the model name “MN1” in the fee table 144, and calculates a no-subscription print cost, which is a print cost for the user that has not subscribed to the subscription service, based on the average number of used sheets and the print fee “1.5 yen/sheet”. Then, the SP server 100 calculates the first cost benefit by subtracting the first target print cost from the non-subscription print cost and also calculates the second cost benefit by subtracting the second target print cost from the non-subscription print cost. By contrast, if the user has already subscribed to the subscription service, the SP server 100 specifies the contracted plan information associated with the account information “AC1” in the user table 140, and then calculates a print cost corresponding to the plan of the subscription service the user has subscribed to based on the average number of used sheets. Hereinafter, this print cost is termed “subscription print cost”. The SP server 100 then calculates the first cost benefit by subtracting the first target print cost from the subscription print cost and also calculates the second cost benefit by subtracting the second target print cost from the subscription print cost.

In T48, the SP server 100 determines whether the first target combination information and the second target combination information both include the model name “MN1”. When determining that the first target combination information and the second target combination information both include the model name “MN1” (YES in T48), the SP server 100 proceeds to T60. By contrast, when determining that at least one of the first target combination information and the second target combination information does not include the model name “MN1” (NO in T48), the SP server 100 proceeds to T50. In T50, the SP server 100 specifies a model name that is different from the model name “MN1” and included in at least one of the first target combination information and the second target combination information. Hereinafter, this different model name is termed “target model name”. The SP server 100 then specifies the printer price associated with the target model name in the fee table 144.

In T60, the SP server 100 sends result screen data representing a result screen to the terminal device 50. The result screen data includes first result information including the first target combination information, the first target print cost, and the first cost benefit and second result information including the second target combination information, the second target print cost, and the second cost benefit. If the first target combination information does not include the model name “MN1”, the first result information further includes the printer price, while if the second target combination information does not include the model name “MN1”, the second result information further includes the printer price.

In response to receiving the result screen data from the SP server 100 in T60, the terminal device 50 displays the result screen in T62. Thus, the user is able to visually recognize plans of the subscription service useful to the user, etc. from the result screen.

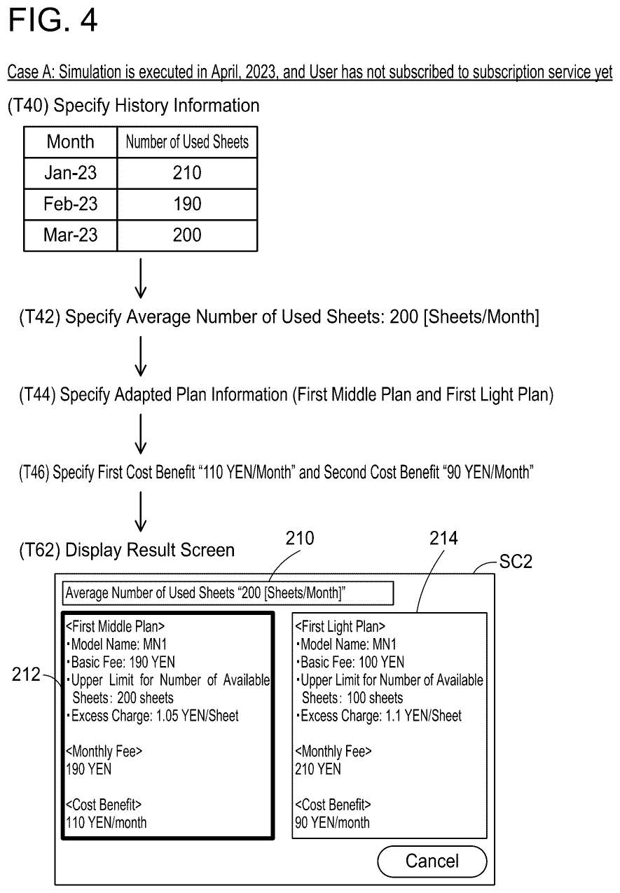

### (Case A: FIG. 4)

Referring to FIGS. 4 to 6, specific cases are described. For Case A of FIG. 4, the sequence from T20 to T62 in FIG. 3 is executed in April 2023. In the history table 146, “210”, “190”, and “200” are stored as the number of used sheets in March 2023, the number of used sheets in February 2023, and the number of used sheets in January 2023, respectively. The user has not subscribed to the subscription service yet.

The SP server 100 specifies the history information for the serial number “SN1” in the history table 146 (T40). Then, the SP server 100 averages the cumulative number of used sheets “210” in March 2023, the cumulative number of used sheets “190” in February 2023, and the cumulative number of used sheets “200” in January 2023 to calculate an average “200” as the average number of used sheets “200 sheets/month” (T42). The SP server 100 then calculates a print cost per month for each plan based on the average number of used sheets “200 sheets/month” and the plan table 142. In the present case, a print cost “190 yen” corresponding to the first middle plan is the lowest and a print cost “210” corresponding to the first light plan is the second lowest. That is, the print cost “190 yen” and the print cost “210 yen” are the first target print cost and the second target print cost, respectively. Thus, the SP server 100 specifies combination information that includes the model name “MN1” and the plan information including the first middle plan as the first target combination information and also specifies combination information that includes the model name “MN1” and the plan information including the first light plan as the second target combination information (T44).

Then, the SP server 100 determines that the user has not subscribed to the subscription service yet, specifies the print fee “1.5 yen/sheet” associated with the model name “MN1” in the fee table 144, and calculates a no-subscription print cost “300 yen” based on the average number of used sheets “200 sheets/month” and the print fee “1.5 yen/sheet”. The SP server 100 then calculates a first cost benefit “110 yen/month” and a second cost benefit “90 yen/month” based on the first target print cost “190 yen”, the second target print cost “210 yen”, and the no-subscription print cost “300 yen” (T46). Then, the SP server 100 determines that the first target combination information and the second target combination information both include the model name “MN1” (YES in T48). In this case, the SP server 100 sends the terminal device 50 result screen data that includes first result information including the first target combination information, the first target print cost, and the first cost benefit and second result information including the second target combination information, the second target print cost, and the second cost benefit (T60).

In response to receiving the result screen data from the SP server 100, the terminal device 50 displays a result screen SC2 (T62). The result screen SC2 includes the average number of used sheets 210, the first result information 212, the second result information 214, and a cancel button. The first result information 212 including the first target combination information is shown more emphasized than the second result information including the second target combination information. The first result information 212 includes the model name “MN1”, the plan information including the first middle plan, the monthly fee “190 yen” of the first target print cost, and the first cost benefit “110 yen/month”. The second result information 214 includes the model name “MN1”, the plan information including the first light plan, the monthly fee “210 yen” of the second target print cost, and the second cost benefit “90 yen/month”. For example, the user can subscribe to the first middle plan by performing an operation on the first result information 212.

As described, the SP server 100 specifies the combination information with the lowest print cost as the first combination information. Thus, the user is able to know the most cost-advantageous combination information, specifically plan information.

The SP server 100 sends the terminal device 50 the first result information including the first target combination information and the first cost benefit. Thus, the user can recognize the benefit of subscribing to the subscription service.

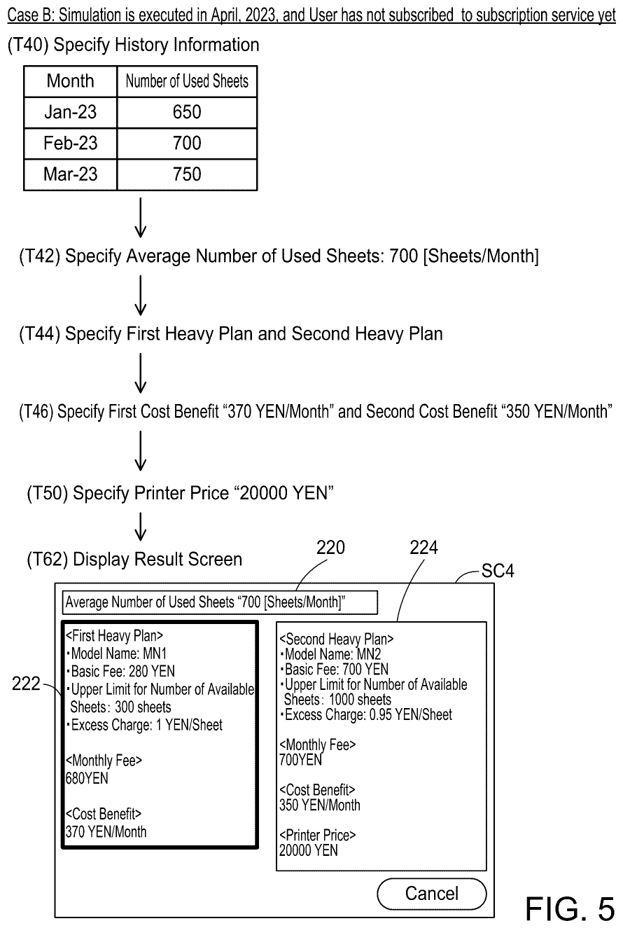

### (Case B: FIG. 5)

For Case B of FIG. 5, the sequence from T20 to T62 in FIG. 3 is executed in April 2023. In the history table 146, “650”, “700”, and “750” are stored as the number of used sheets in January 2023, the number of used sheets in February 2023, and the number of used sheets in March 2023, respectively. The user has not subscribed to the subscription service yet.

The SP server 100 calculates the average number of used sheets “700 sheets/month” in the same manner as Case A (T42). Then, the SP server 100 calculates a print cost per month for each plan based on the average number of used sheets “700 sheets/month” and the plan table 142. In the present case, a print cost “680 yen” corresponding to the first heavy plan is the lowest and a print cost “700 yen” corresponding to the second heavy plan is the second lowest. That is, the print cost “680 yen” and the print cost “700 yen” are the first target print cost and the second target print cost, respectively. Thus, the SP server 100 specifies combination information that includes the model name “MN1” and the plan information including the first heavy plan as the first target combination information and also specifies combination information that includes the model name “MN2” and the plan information including the second heavy plan as the second target combination information (T44).

Then, the SP server 100 determines that the user has not subscribed to the subscription service yet and calculates a first cost benefit “370 yen/month” and a second cost benefit “350 yen/month” in the same manner as Case A (T46 in FIG. 3). The SP server 100 then determines that the second target combination information does not include the model name “MN1” (NO in T48). In this case, the SP server 100 specifies a printer price “20,000 yen” associated with the model name “MN2” in the fee table 144, which is included in the second target combination information (T50). The SP server 100 then sends the terminal device 50 result screen data that includes first result information including the first target combination information, the first target print cost, and the first cost benefit and second result information including the second target combination information, the second target print cost, the second cost benefit, and the printer price (T60).

In response to receiving the result screen data from the SP server 100, the terminal device 50 displays a result screen SC4 (T62). The result screen SC4 includes the average number of used sheets 220, the first result information 222, the second result information 224, and a cancel button. The first result information 222 includes the model name “MN1”, the plan information including the first heavy plan, the monthly fee “680 yen”, and the first cost benefit “370 yen/month”. The second result information 224 includes the model name “MN2”, the plan information including the second heavy plan, the monthly fee “700 yen”, the second cost benefit “350 yen/month”, and the printer price “20,000 yen”.

As described, the SP server 100 sends the terminal device 50 the result screen data including the first target combination information and the second target combination information. Thus, the user can select a suitable plan from multiple plans.

The SP server 100 sends the terminal device 50 the result screen data that includes the first target combination information including the model name “MN1” and the second target combination information including the model name “MN2”. Thus, the user is able to know plan information for a printer different from the user's printer.

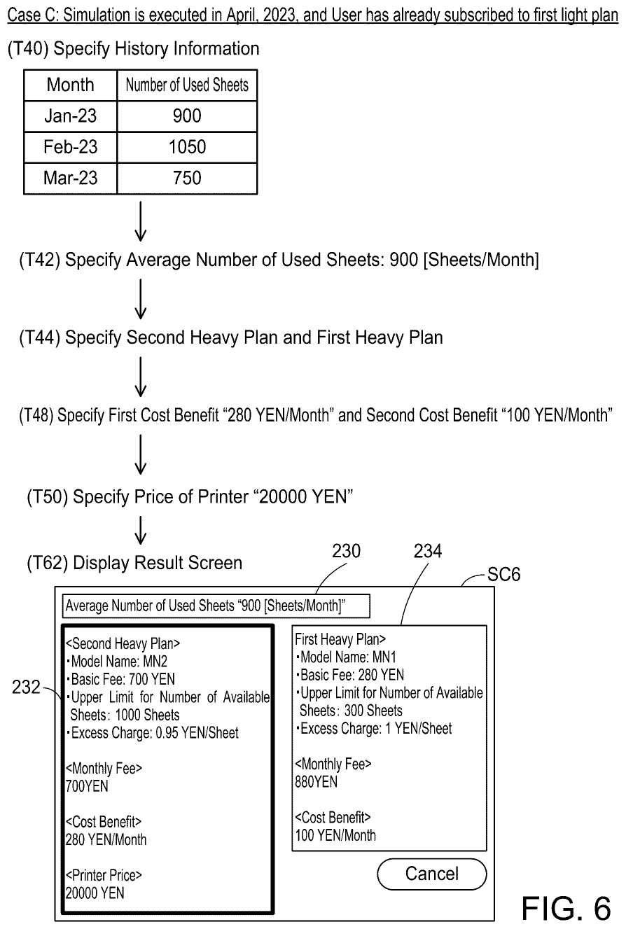

### (Case C: FIG. 6)

For Case C of FIG. 6, the sequence from T20 to T62 in FIG. 3 is executed in April 2023. In the history table 146, “900”, “1050”, and “750” are stored as the number of used sheets in January 2023, the number of used sheets in February 2023, and the number of used sheets in March 2023, respectively. The user has already subscribed to the subscription service.

The SP server 100 calculates the average number of used sheets “900 sheets/month” in the same manner as Case B (T42). Then, the SP server 100 calculates a print cost per month for each plan based on the average number of used sheets “900 sheets/month” and the plan table 142. In the present case, a print cost “700 yen” corresponding to the second heavy plan is the lowest and a print cost “880 yen” corresponding to the first heavy plan is the second lowest. That is, the print cost “700 yen” and the print cost “880 yen” are the first target print cost and the second target print cost, respectively. Thus, the SP server 100 specifies combination information that includes the model name “MN2” and the plan information including the second heavy plan as the first target combination information and also specifies combination information that includes the model name “MN1” and the plan information including the first heavy plan as the second target combination information (T44).

Then, the SP server 100 determines that the user has already subscribed to the first light plan. In this case, the SP server 100 calculates a target print cost “980 yen” based on the average number of used sheets “900 sheets/month”. The SP server 100 then calculates a first cost benefit “280 yen/month” and a second cost benefit “100 yen/month” based on the first target print cost “700 yen”, the second target print cost “880 yen”, and the target print cost “980 yen” (T46). Then, the SP server 100 specifies the printer price “20,000 yen” associated with the target model name “MN2” in the same manner as Case B (T50). The SP server 100 then sends the terminal device 50 result screen data that includes first result information including the first target combination information, the first target print cost, the first cost benefit, and the printer price and second result information including the second target combination information, the second cost benefit, and the second target print cost (T60).

In response to receiving the result screen data from the SP server 100, the terminal device 50 displays a result screen SC6 (T62). The result screen SC6 includes the average number of used sheets 230, the first result information 232, the second result information 234, and a cancel button. The first result information 232 includes the model name “MN2”, the plan information including the second heavy plan, the monthly fee “700 yen”, the first cost benefit “280 yen/month”, and the printer price “20,000 yen”. The second result information 234 includes the model name “MN1”, the plan information including the first heavy plan, the monthly fee “880 yen”, and the second cost benefit “280 yen/month”.

As described, the SP server 100 sends the terminal device 50 the first result information including the first target combination information and the first cost benefit. Thus, the user is able to know the benefit of changing the plan of the subscription service.

The SP server 100 sends the terminal device 50 the first result information including the first target combination information and the printer price. Thus, the user is able to know the cost required to purchase a new printer.

### Advantageous Effects of Embodiment

According to the embodiment, the SP server 100 acquires the cumulative number of used sheets (T12 in FIG. 3), specifies first target combination information adapted to the cumulative number of used sheets from among a plurality of combination information stored in the memory 134 (T44), and outputs the first target combination information (T60). Thus, the SP server 100 can output useful information to the user.

### (Correspondence Relationships)

The SP server 100 and the printer 10 are examples of “control device” and “printer”, respectively. The cumulative number of used sheets is an example of “printer information”. First target combination information is an example of “first combination information”. In FIG. 4, the model name “MN1” is an example of “first model name”. In FIGS. 5 and 6, the model name “MN2” is an example of “first model name”. In FIG. 4, the plan information including the first middle plan is an example of “first plan information”. In FIGS. 5 and 6, the plan information including the second heavy plan is an example of “first plan information”. The printer 10 is an example of “specific printer”. The print media is an example of “consumable article”. The cumulative number of used sheets is an example of “usage information”. The no-subscription print cost is an example of “first print cost”. The first target print cost is an example of “second print cost”. In FIGS. 4 and 5, the first cost benefits are examples of “first difference information”. The first light plan is an example of “specific plan”. The subscription print cost is an example of “third print cost”. In FIG. 6, the first cost benefit is an example of “second difference information”. In Case B shown in FIG. 5, the printer having the model name “MN2” is an example of “first printer”. The model name “MN1” is an example of “specific model name”. In Case B shown in FIG. 5, the printer price is an example of “cost information”. Second target combination information is an example of “second combination information”. In FIGS. 5 and 6, the model name “MN1” is an example of “second model name”. In FIGS. 5 and 6, the plan information including the first heavy plan is an example of “second plan information”. The instruction in T34 of FIG. 3 is an example of “predetermined instruction”.

T12 in FIG. 3 is an example of “acquire printer information”. T44 is an example of “specify first combination information”. T60 is an example of “output the first combination information”.

### Second Embodiment

A communication system 2 according to a second embodiment is described. In the second embodiment, rental fees are stored instead of the printer prices in the fee table 144 in the SP server 100. A rental fee is a fee per month required to rent a printer.

In the second embodiment, the SP server 100 specifies a target model name and also specifies the rental fee associated with the target model name in the fee table 144 in T50 of FIG. 3. Thus, if the first target combination information does not include the model name “MN1”, first result information further includes the rental fee, while if the second target combination information does not include the model name “MN1”, second result information further includes the rental fee.

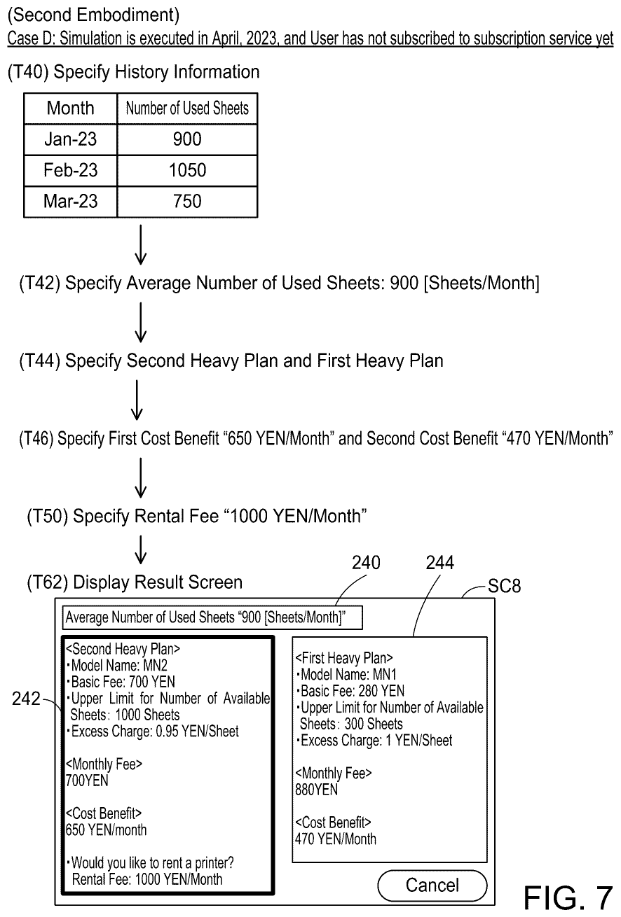

### (Case D: FIG. 7)

Referring to FIG. 7, specific Case D according to this embodiment is described. The initial state of Case D is the same as that of Case C shown in FIG. 6 except that the user has not subscribed to the subscription service yet.

The SP server 100 calculates the average number of used sheets “900 sheets/month” in the same manner as Case C (T42), and specifies combination information that includes the model name “MN2” and the plan information including the second heavy plan as first target combination information and also specifies combination information that includes the model name “MN1” and the plan information including the first heavy plan as second target combination information (T44).

Then, the SP server 100 determines that the user has not subscribed to the subscription service yet, and calculates a first cost benefit “650 yen/month” and a second cost benefit “470 yen/month” in the same manner as Case A (T46 in FIG. 3). The SP server 100 then determines that the first target combination information does not include the model name “MN1” (NO in T48). In this case, the SP server 100 specifies a rental fee “1000 yen/month” associated with the target model name “MN2” in the fee table 144, which is included in the first target combination information (T50). Then, the SP server 100 sends the terminal device 50 result screen data that includes first result information including the first target combination information, the first target print cost, the first cost benefit, and rental information and second result information including the second target combination information, the second target print cost, and the second cost benefit (T60). The rental information includes a message that suggests the user rent a printer and the rental fee “1000 yen/month”.

In response to receiving the result screen data from the SP server 100, the terminal device 50 displays a result screen SC8 (T62). The result screen SC8 includes the average number of used sheets 240, the first result information 242, the second result information 244, and a cancel button. The first result information 242 includes the model name “MN2”, the plan information including the second heavy plan, the monthly fee “700 yen”, the cost benefit “650 yen/month”, and the rental information. The second result information 244 includes the model name “MN1”, the plan information including the first heavy plan, the monthly fee “880 yen”, and the cost benefit “470 yen/month”.

### Third Embodiment

A communication system 2 according to a third embodiment is described. The communication system 2 according to the third embodiment is the same as the communication system 2 according to the first embodiment except that the former does not comprise the printer 10. That is, in the third embodiment, the user does not own the printer 10.

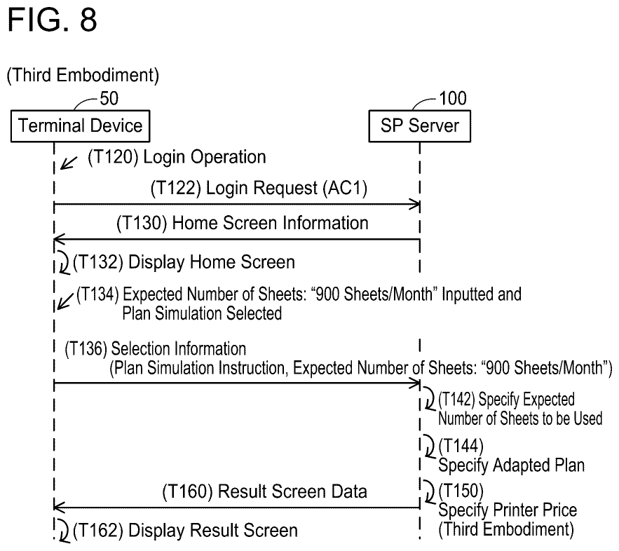

### (Process Executed by Devices: FIG. 8)

Referring to FIG. 8, a process executed by the devices 50 and 100 is described.

In response to receiving a login operation to log into the SP server 100 from the user in T120, the terminal device 50 sends a login request including the account information “AC1” to the SP server 100 in T122, receives home screen information from the SP server 100 in T130, and displays a home screen in T132. The home screen includes a plurality of icons related to the subscription service. In T134, the terminal device 50 receives an operation of selecting the icon and an operation of inputting the number of sheets expected to be used “900 sheets/month” from the user. Hereinafter, the number of sheets expected to be used is simply termed “the expected number of sheets”. The expected number of sheets is the number of sheets expected to be used by the user within a unit period which is a month. In T136, the terminal device 50 sends selection information including the plan simulation instruction and the expected number of sheets “900 sheets/month” to the SP server 100.

In response to receiving the selection information from the terminal device 50 in T136, the SP server 100 specifies the expected number of sheets “900 sheets/month” included in the selection information in T142. In T144, the SP server 100 calculates a plurality of print costs corresponding to a plurality of plan information based on the expected number of sheets and the plan table 142 and specifies first target combination information and second target combination information adapted to the expected number of sheets. In T150, the SP server 100 specifies printer prices. Specifically, the SP server 100 first specifies a first target model name and a second target model name included in the first target combination information and the second target combination information, respectively, and then specifies a first printer price and a second printer price associated with the first target model name and the second target model name, respectively in the fee table 144.

In T160, the SP server 100 sends result screen data representing a result screen to the terminal device 50. This result screen data includes first result information including the first target combination information, the first target print cost, and the first printer price and second result information including the second target combination information, the second target print cost, and the second printer price. T162 is the same as T62 in FIG. 3.

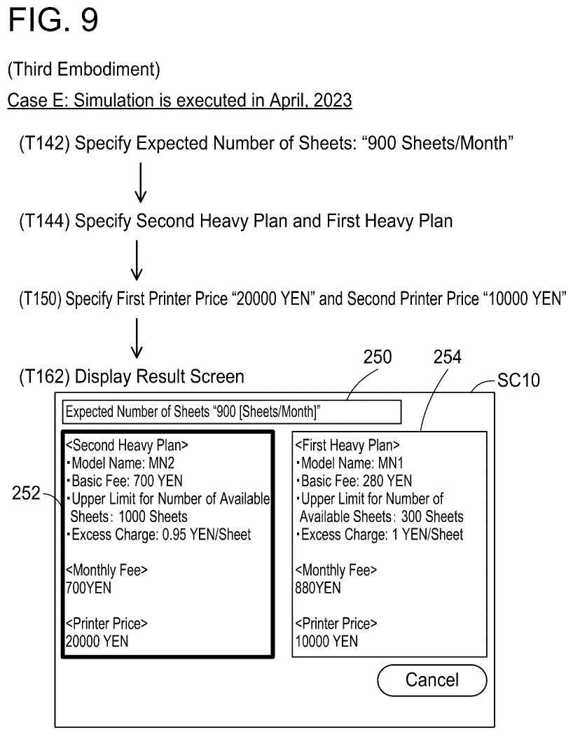

### (Case E: FIG. 9)

Referring to FIG. 9, specific Case E according to this embodiment is described. For Case E, the sequence from T120 to T162 in FIG. 8 is executed in April 2023.

In response to receiving the selection information from the terminal device 50, the SP server 100 specifies the expected number of sheets “900 sheets/month” included in the selection information (T142). Then, the SP server 100 calculates a print cost per month for each plan based on the expected number of sheets “900 sheets/month” and the plan table 142. In the present case, a print cost “700 yen” corresponding to the second heavy plan is the lowest and a print cost “880 yen” corresponding to the first heavy plan is the second lowest. That is, the print cost “700 yen” and the print cost “880 yen” are the first target print cost and the second target print cost, respectively. Thus, the SP server 100 specifies combination information that includes the model name “MN2” and the plan information including the second heavy plan as the first target combination information and also specifies combination information that includes the model name “MN1” and the plan information including the first heavy plan as the second target combination information (T144).

Then, the SP server 100 specifies the model name “MN2” included in the first target combination information and the second target model name “MN1” included in the second target combination information, and also specifies the first printer price “20,000 yen” associated with the first target model name “MN2” and the second printer price “10,000 yen” associated with the second target model name “MN1” in the fee table 144 (T150). The SP server 100 then sends the terminal device 50 result screen data that includes first result information including the first target combination information, the first target print cost, and the first printer price and second result information including the second target combination information, the second target print cost, and the second printer price (T160).

In response to receiving the result screen data from the SP server 100, the terminal device 50 displays a result screen SC10. The result screen SC10 includes the expected number of sheets 250, the first result information 252, the second result information 254, and a cancel button. The first result information 252 includes the model name “MN2”, the plan information including the first heavy plan, the monthly fee “700 yen”, and the first printer price “20,000 yen”. The second result information 254 includes the model name “MN1”, the plan information including the first heavy plan, the monthly fee “880 yen”, and the second printer price “10,000 yen”. For example, the user can subscribe to the second heavy plan and purchase a printer having the model name “MN2” by performing an operation on the first result information 252.

As described, the SP server 100 specifies the combination information with the lowest print cost as the first combination information. Thus, the user is able to know the most cost-advantageous combination information, specifically plan information.

### (Correspondence Relationship)

The expected number of sheets is an example of “expected usage information”.

### Fourth Embodiment

A communication system 2 according to a fourth embodiment is described. The communication system 2 according to the fourth embodiment is the same as the communication system 2 according to the second embodiment except that the former does not comprise the printer 10. That is, in the fourth embodiment, rental fees are stored in the fee table 144 in the SP server 100.

In T144 of FIG. 8, the SP server 100 calculates, for each of a plurality of plan information, a sum (i.e., monthly fee) of a print cost corresponding to the plan information and a rental fee for a printer having the model name supporting the plan information based on the plan table 142 and the fee table 144. Then, the SP server 100 specifies the combination information that includes the plan information resulting in the lowest monthly fee as first target combination information and also specifies the combination information that includes the plan information resulting in the second lowest monthly fee as second target combination information. In T160, the SP server 100 sends the terminal device 50 result screen data representing a result screen. This result screen data includes first result information including the first target combination information, first rental information, and a first monthly fee and second result information including the second target combination information, second rental information, and a second monthly fee.

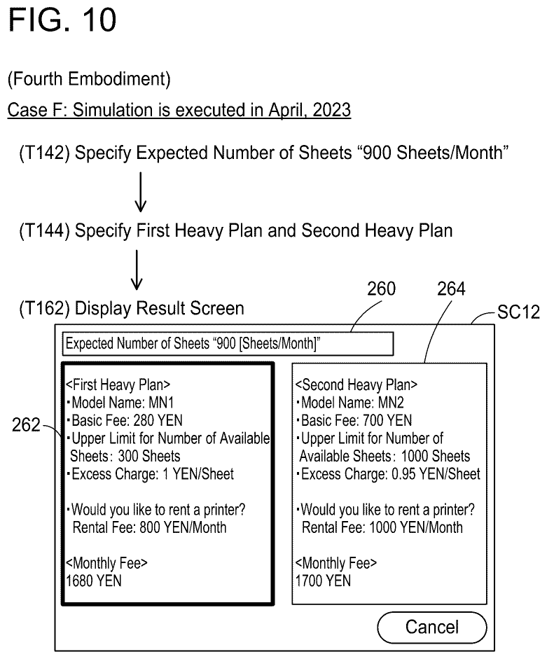

### (Case F: FIG. 10)

Referring to FIG. 10, specific Case F according to this embodiment is described. The initial state of Case F is the same as that of Case E shown in FIG. 9.

The SP server 100 specifies the expected number of sheets “900 sheets/month” included in selection information (T142). The SP server 100 then calculates a monthly fee for each of the plurality of plan information. In the present case, a monthly fee “1,680 yen” corresponding to the first heavy plan is the lowest and a monthly fee “1,700 yen” corresponding to the second heavy plan is the second lowest. That is, the monthly fee “1,680 yen” and the monthly fee “1,700 yen” are the first monthly fee and the second monthly fee, respectively. Thus, the SP server 100 specifies combination information that includes the model name “MN1” and the plan information including the first heavy plan as the first target combination information and also specifies combination information that includes the model name “MN2” and the plan information including the second heavy plan as the second target combination information (T144). Then, the SP server 100 sends the terminal device 50 result screen data that includes first result information including the first target combination information, first rental information, and the first monthly fee and second result information including the second target combination information, second rental information, and the second monthly fee (T160).

In response to receiving the result screen data from the SP server 100, the terminal device 50 displays a result screen SC12 (T162). The result screen SC12 includes the expected number of sheets 260, the first result information 262, the second result information 264, and a cancel button. The first result information 252 includes the model name “MN1”, the plan information including the first heavy plan, the first rental information, and the first monthly fee “1,680 yen”. The second result information 264 includes the model name “MN2”, the plan information including the second heavy plan, second rental information, and the second monthly fee “1,700 yen”. For example, the user can subscribe to the first heavy plan and rent a printer having the model name “MN1” by performing an operation on the first result information 262.

(Modification 1) The SP server 100 may be a single server or a combination of multiple servers. For example, the SP server 100 may be a combination of a first server and a second server. In this case, the first server may execute T14 in FIG. 3, and the second server may execute the sequence from T22 onward.

(Modification 2) The “printer information” is not limited to the cumulative number of used sheets and the expected number of sheets, and may be a model name of a printer. In this modification, the SP server 100 sends result screen data including a model name and the plan information associated with the model name to the terminal device.

(Modification 3) The “consumable article” is not limited to print media and may be cartridges.

(Modification 4) In T44 of FIG. 3, the SP server 100 may specify target combination information based on differences between the average number of used sheets and the upper limits for the number of available sheets. For example, the SP server 100 may specify combination information that includes the plan information resulting in the smallest difference as first target combination information. In this modification, T46 may be omitted.

(Modification 5) In the first and second embodiments, T46 in FIG. 3 may be omitted. In this modification, “calculate a first print cost and a second print cost”, “calculate first difference information”, “calculate a third print cost and a second print”, and “calculate second difference information” may be omitted.

(Modification 6) In the first and second embodiments, T48 and T50 in FIG. 3 may be omitted.

(Modification 7) The SP server 100 may be configured to output only one target combination information or three or more target combination information.

(Modification 8) In the first and second embodiments, the SP server 100 may be configured to output only combination information including plan information associated with the model name of the user's printer. In another modification, in the first and second embodiments, the SP server 100 may be configured to output only combination information including plan information associated with model names different from the model name of the user's printer.

(Modification 9) The “unit period” is not limited to one month and may be another period such as one week, half a month, half a year, one year, etc.

(Modification 10) In T44 of FIG. 3, the SP server 100 may specify target combination information based on the number of subscribers. For example, the SP server 100 may specify the combination information including the plan information having the largest number of subscribers as first target combination information. In this modification, T46 may be omitted.

(Modification 11) In the result screens, the first result information and the second result information may be displayed in the same manner.

(Modification 12) The “control device” is not limited to the SP server 100 and may be the controller 30 of the printer 10, the terminal device 50, or the like.

(Modification 13) The SP server 100 may combine the serial number “SN1” and the model name “MN1” together and store the combination as one combined information. In this modification, the SP server 100 derives the serial number “SN1” and the model name “MN1” from the combined information including the seral number “SN1” and the model name “MN1”. In other words, the serial number “SN1” and the model name “MN1” may be stored in the SP server 100 in any manner as long as they can be derived.

(Modification 14) In the embodiments described above, the steps in FIGS. 3 and 8 are implemented by software, however, at least one of these steps may be implemented by hardware such as a logic circuit.

What is claimed is:

1. A non-transitory computer-readable recording medium storing computer-readable instructions for a control device comprising a processor,
wherein the computer-readable instructions, when executed by the processor, cause the control device to:
acquire printer information related to a printer;
specify first combination information adapted to the printer information from among a plurality of combination information in a memory, wherein each of the plurality of combination information indicates a combination of a model name of a printer and plan information indicating a content of a plan included in a service related to the printer, and the first combination information includes a first model name and first plan information; and
output the first combination information.

2. The non-transitory computer-readable recording medium according to claim 1, wherein the printer information is acquired from a specific printer, and the printer information includes usage information related to a usage amount of a consumable article used in the specific printer.

3. The non-transitory computer-readable recording medium according to claim 2, wherein the first combination information is specified from among the plurality of combination information based on the usage information, the first combination information being of greatest benefit to a user of the specific printer.

4. The non-transitory computer-readable recording medium according to claim 2, wherein the computer-readable instructions, when executed by the processor, further cause the control device to:
under a situation where a user of the specific printer has not subscribed to the service yet, calculate a first print cost and a second print cost based on the usage information, and calculate first difference information indicating a difference between the first print cost and the second print cost, wherein the first print cost is a print cost charged in a case where the user does not subscribe to the service, and the second print cost is a print cost corresponding to a plan indicated by the first plan information,
wherein the first combination information and the first difference information are outputted.

5. The non-transitory computer-readable recording medium according to claim 2, wherein the computer-readable instructions, when executed by the processor, further cause the control device to:
under a situation where a user of the specific printer has already subscribed to a specific plan of the service, calculate a third print cost and a second print cost based on the usage information, and calculate second difference information indicating a difference between the third print cost and the second print cost, wherein the third print cost is a print cost corresponding to the specific plan, and the second print cost is a print cost corresponding to a plan indicated by the first plan information,
wherein the first combination information and the second difference information are outputted.

6. The non-transitory computer-readable recording medium according to claim 1, wherein the printer information includes a specific model name of a specific printer,
wherein in a case where the specific model name in the printer information does not match the first model name in the first combination information, the first combination information and cost information for purchasing a first printer having the first model name are outputted, and
in a case where the specific model name matches the first model name, the first combination information is outputted and the cost information is not outputted.

7. The non-transitory computer-readable recording medium according to claim 1, wherein the printer information includes a specific model name of a specific printer,
wherein in a case where the specific model name in the printer information does not match the first model name in the first combination information, the first combination information and rental information for renting a first printer having the first model name are outputted, and
in a case where the specific model name matches the first model name, the first combination information is outputted and the rental information is not outputted.

8. The non-transitory computer-readable recording medium according to claim 1, wherein in addition to the first combination information, second combination information adapted to the printer information is specified from among the plurality of combination information,
the second combination information includes a second model name and second plan information, and
the first combination information and the second combination information are outputted.

9. The non-transitory computer-readable recording medium according to claim 8, wherein in a case where a predetermined instruction is received from a user, the first combination information is specified,
the first model name is a specific model name of a specific printer that is currently used by the user, and
the second model name is different from the specific model name.

10. The non-transitory computer-readable recording medium according to claim 1, wherein the printer information includes expected usage information related to an amount of a consumable article expected to be used within a unit period, and
the amount of the consumable article expected to be used is designated by a user.

11. The non-transitory computer-readable recording medium according to claim 10, wherein the first combination information is specified from among the plurality of combination information based on the expected usage information, the first combination information being of greatest benefit to the user.

12. A control device comprising:
a controller configured to:
acquire printer information related to a printer;
specify first combination information adapted to the printer information from among a plurality of combination information in a memory, wherein each of the plurality of combination information indicates a combination of a model name of a printer and plan information indicating a content of a plan included in a service related to the printer, and the first combination information includes a first model name and first plan information; and
output the first combination information.

13. A method executed by a control device, the method comprising:
acquiring printer information related to a printer;
specifying first combination information adapted to the printer information from among a plurality of combination information in a memory, wherein each of the plurality of combination information indicates a combination of a model name of a printer and plan information indicating a content of a plan included in a service related to the printer, and the first combination information includes a first model name and first plan information; and
outputting the first combination information.
